(19) United States
(12) Patent Application Publication
(10) Pub. No.: US 2008/0283187 A1
(43) Pub. Date: Nov. 20, 2008

(54) Decorating Method For Sports Equiment By Imprinting Synthetic Material Films As Well As A Film For Carrying Out The Method

(75) Inventor: Anita Ornetsmuller, Obernberg (AT)

Correspondence Address: LERNER GREENBERG STEMER LLP, P O BOX 2480, HOLLYWOOD, FL, 33022-2480, US

(73) Assignee: Fischer Gesellschaft m.b.H, Ried im Innkreris (AT)

(21) Appl. No.: 11/658,483

(22) PCT Filed: Jun. 28, 2005
(86) PCT No.: PCT/AT2005/000237

§ 371 Date: Jan. 25, 2007

(30) Foreign Application Priority Data
Jul. 26, 2004 (AT) A 1274/2004

(51) Int. Cl. B32B 37/00; B32B 5/00

(52) U.S. Cl. 156/277; 428/141

(57) ABSTRACT

To obtain three-dimensional depth effects, a decorating method is provided for sports equipment, in particular skis, snowboards and the like, by imprinting synthetic material films with surface texture so as to create a decorative changing image and/or animation effect. The synthetic material films correspond to an optical lens, in particular lenticular grid films. The film is imprinted in the screen printing method, whereupon the film is joined to the piece of sports equipment. On its planar side, the film is provided with geometrically arranged motifs or image elements, between which optionally voids are incorporated.

The invention relates to a decorating method for sports equipment, in particular sports equipment for sliding movement, such as skis, snowboards and the like, according to the preamble of claim 1.

For obtaining a decorative appearance, imprints are made on the surface of such sports equipment.

This is done, e.g., by directly printing the desired décor on such sports equipment, e.g. by screen printing methods, pad printing methods, or in a preceding working step. It is also known to design dyed films on one side by means of various printing methods, such as screen printing methods, thermal diffusion printing methods, digital printing methods, pad printing methods, gravure printing and the like. This designed side forms the ski surface. With skis and snowboards, the imprinted films are co-inserted in the ski press during assembly of the individual components and assembled simultaneously with the remaining components. Alternatively, this ski blank can be joined to the previously designed décor layer in a first production step.

This variant has the drawback that the laboriously applied decorative design will be greatly damaged already after a short use, e.g. by the steel edges, and, thus, will become unsightly within a short period of time.

If surfaces produced in this way are provided with a transparent cover varnish, the wear resistance can be increased slightly, yet this does not constitute a satisfactory solution, either.

Over the years, the use of so-called transparent surfaces has prevailed which are designed according to the printing methods set out above on that side which later on will come to lie in the direction of the ski body.

As a rule, the thicknesses of these transparent films are in the order of 50μ to 1000μ. As a rule, thermoplastic materials, such as, e.g., from the group of polyamides, the thermoplastic polyurethanes, thermoplastic polyesters, polymethylmethacrylate, polycarbonate, polystyrenes and the blends thereof, as well as polyolefines are used, yet it must be said that also films of duroplastic materials may be employed.

In particular skis and snowboards can be decorated in this way in an excellent and simple manner, while also a sufficient wear protection is provided.

DE 44 42 210 A1 shows a method for producing three-dimensional images as well as a lenticular grid film and a printer for carrying out the method with a multi-layered composite film, whose first layer which forms the cylinder lenses, is optimized with a view to its optical properties (refractive index; transparency), and whose second layer is optimized with a view to its capacity of being imprinted by an electrostatic printer and/or an ink-jet printer. The image which consists of several pixels corresponding to the resolution of the printer used, which image, moreover, has a strip texture, is directly printed to the smooth rear side of the lenticular grid film, in particular in the focal plane of the lenticular grid film.

DE 295 12 971 U1 shows an advertising medium which is designed as a sports equipment, in particular as a ski, wherein the entire external surface, or large-area regions, respectively, of the advertising medium is (are) provided with a layer-like coating in the form of a prism image. The prism image with changing effect is directly integrated into the external surface of the advertising medium, or subsequently glued or laminated thereto, respectively.

Summing up, it is noted that the use of lenticular grid films with correspondingly moving images, as apparent from the references, is prior art, yet it is produced by means of offset-printing or ink-jet printing or the like electronic printing media.

DE 101 00 692 A1 shows a method of producing a décor film having a three-dimensional effect, wherein a transparent, translucent film of thermoplastic synthetic material is produced, pulled through a nip formed between an embossing roll and a counter-roll and, thus, on its upper side is provided with a geometric embossed texture comprising a plurality of convex mounds in grid form, wherein the film on its lower side is guided over at least one grid roll having a dot-printing grid for applying a printing ink and is provided with a printed pattern in the form of a dot-printing grid.

In the priority interval, EP 1 445 124 A2 has, indeed, appeared which shows a decorative surface material with a lenticular film in the form of a weather-resistant synthetic material film for producing a decorative changing image and/or animation effect which, on its rear side, is provided with an imprint for generating the decorative changing image and/or animation effect, printing being direct, i.e. without additional printing paper, on the preferably pre-treated film by means of common printing techniques, such as thermal transfer, offset or screen printing.

The printed publication furthermore shows a snow sports equipment, in particular ski or snowboard, which comprises the decorative surface material at least in partial regions of its surface.

It is an object of the invention to provide a decorating method by means of which three-dimensional effects can be achieved.

According to the invention, this object is achieved by the feature of claim 1.

By the measures according to the invention, new decoration effects, in particular of tilting or moving images, are produced at comparatively low expenditures. Three-dimensional depth effects are achieved, similar to holographic images, and, depending on the angle of viewing the sports equipment, different graphics elements become visible.

Further details of the invention are described in more detail by way of the accompanying drawings which, for the sake of simplicity and for a better overview, are schematic representations.

Therein,

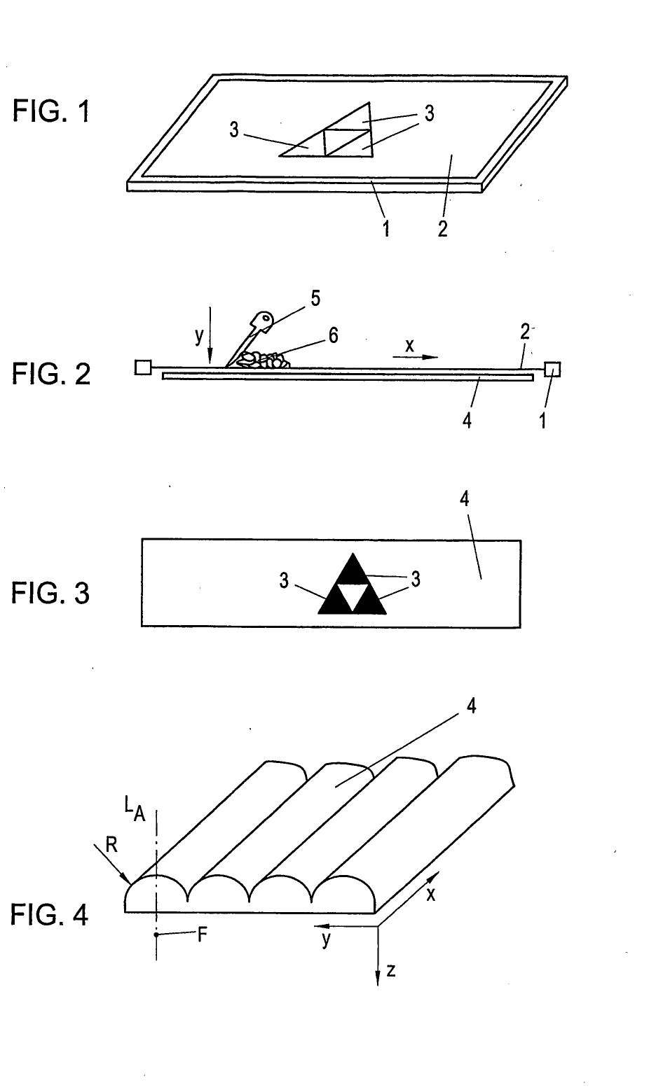

FIG. 1 shows a screen for the screen printing method in a perspective representation;

FIG. 2 shows the principle of screen printing;

FIG. 3 shows an embodiment of a décor;

FIG. 4 shows a surface film in a perspective view;

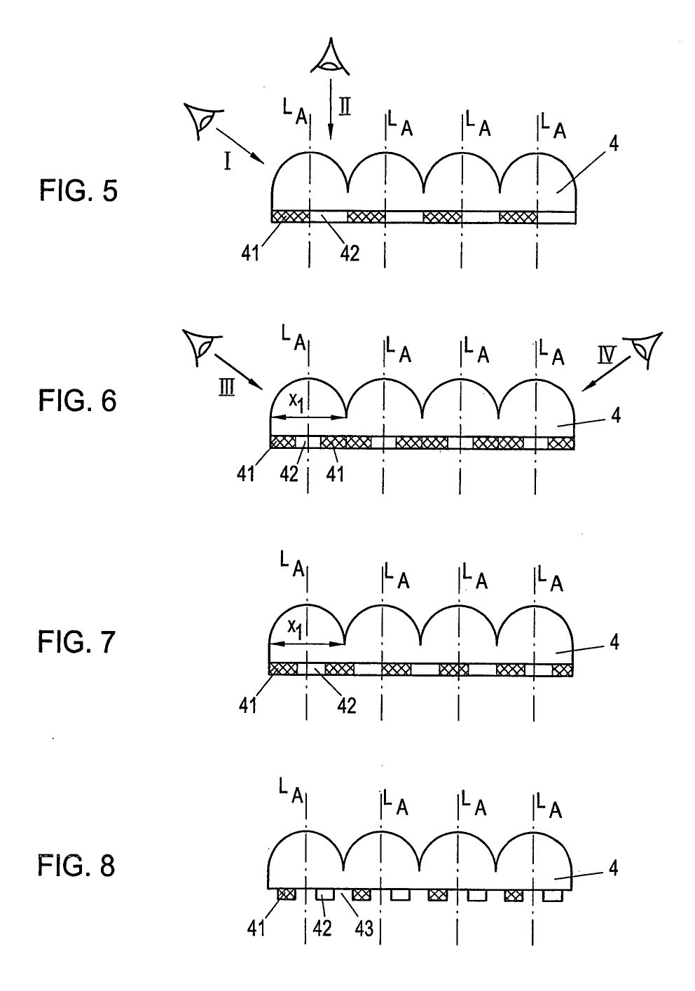

FIGS. 5 to 7 each show a different cross-section of the film according to FIG. 4;

FIG. 8 shows a similar cross-section as FIG. 7, the difference being that voids are incorporated between the motifs;

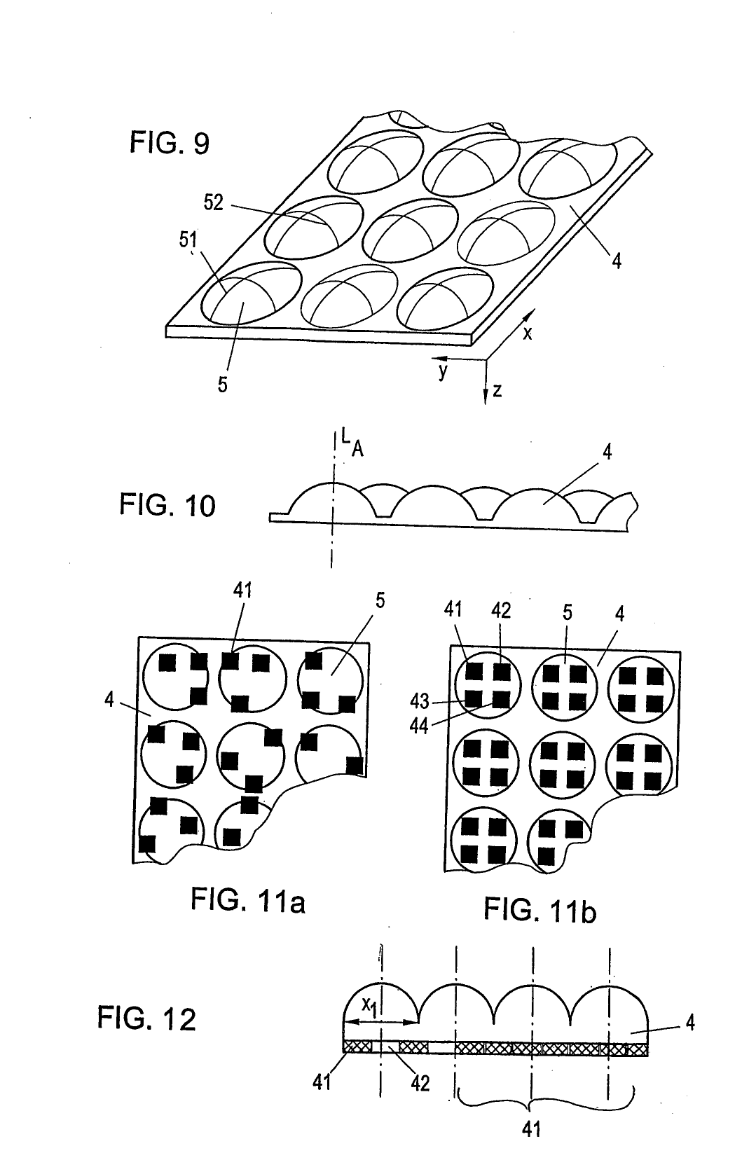

FIG. 9 shows a part of a film with lenticular nodules in a perspective view;

FIG. 10 shows a similar illustration as FIG. 9, yet with offset rows of nodules;

FIGS. 11a and 11b each show a top view onto a part of a film with different motifs; and

FIG. 12 shows a variant of the embodiment according to FIG. 8.

In FIG. 1, a screen frame is denoted by 1, in which a screen 2 is tensioned, in which pores are present between intersecting threads of, e.g., nylon of the screen 2 which, preferably, has the form of a tissue, through which pores a screen printing ink can be pressed.

In the present instance, the screen tissue preferably is completely wetted by means of a UV-curing resin, wherein those sites through which the ink is to be pressed later on during the printing procedure, denoted by 3 in FIG. 1, are covered against UV-light. The thus prepared screen 2 subsequently is cured by UV light being radiated thereon. Those sites which had been covered, can be washed out, whereby the said pores are obtained, in this case in the areas 3.

In FIG. 2, the surface film to be imprinted is denoted by 4, a so-called doctor, scraper or the like by 5, and a preferably highly viscous screen printing ink by 6.

By moving the doctor 5 along the film 4 in the present case, as indicated in FIG. 2, in the direction of arrow X, and simultaneously applying a moderate pressure in the direction of arrow Y, the ink is pressed both through the screen 2 and also at the same time on the film 4 to be imprinted. Thus, as is visible in FIG. 3, the décor is formed in quite simple manner; in this case, three triangles 3 of FIG. 1.

In order to obtain three-dimensional effects, films must be used which more or less have a surface texture which corresponds to an optical lens.

In FIG. 4, such a surface film is schematically illustrated, in this instance by serially arranging lenses of planar-convex cross-sections, the cross-sectional direction being denoted by Y. In X-direction, linear lenticular half cylinders are used in this embodiment.

When looking at the cross-section of an individual strand in FIG. 4, the lens axis is located precisely in the plane of symmetry in Z-direction. In this case, the Z-direction describes that direction from which the observer normally looks on the surface. The focal point F of the individual strand is located at a longer or shorter distance below the film 4. The location of the focal point will substantially depend on the radius R of the lens shown. By this, a certain three-dimensional effect is created which, however, has hardly any effect by itself.

The desired three-dimensional effect is obtained only after imprinting according to the invention. This will be explained in more detail by way of FIGS. 5 to 8.

FIG. 5 shows the cross-section of the film 4 of FIG. 4, which according to this embodiment, is imprinted with two different image elements 41 and 42 on the planar side of the film 4 in the screen printing method. It is visible that each motif 41 extends from the left-hand rim of the lens as far as to the lens axis LA.

Each motif 42 extends from the lens axis LA to the right-hand rim of the respective lens. If such an image is viewed from the angle of view I, in each case only the motif 41 is visible. When changing the angle of view I in the direction of angle of view II, only the motif 42 is visible. When the printed film is continuously moved to and fro between the angles of view, the design will always tilt from motif 41 to 42, and vice versa.

According to the variant of FIG. 6, again two motifs 41 and 42 are applied on film 4, wherein in this case the width X1 of the lens has been divided into three parts, the motif 42 is symmetrically printed around the lens axis LA, each motif 41 is on the left-hand and on the right-hand side, respectively, of the base face of the lens. Designs produced in this manner, when seen in top view, i.e. with the direction of view in lens axis, show only motif 42, when viewed from the left and right-hand side denoted by III+IV, always only show motif 41, the image viewed being a function of the geometric design of the lens surface, depending on which motif is hit by the refracted light rays as a function of the lens curvature.

A special three-dimensional effect is achieved according to the embodiment of FIG. 7. In this instance, the film 4 is imprinted on its planar side with two motifs 41 and 42, which in this case are of equal size, yet in their maximum width are smaller than half the lens width X1. The motifs are serially arranged in alternating sequence over the entire cross-section of the film 4, resulting in an image for the observer, whereby at each angle of view a different image is generated. If a ski which has a surface film provided according to FIG. 7 is turned, one gets an impression as if a three-dimensional image moves over the surface.

FIG. 8 has the same purpose as FIG. 7, yet voids 43 are incorporated between the motifs 41 and 42. In the embodiment according to this variant, by changing the angle of view, a moving picture is achieved the countours of which appear blurred.

In the variant of this embodiment illustrated in FIG. 12, the different images 41 and 42 are only printed over part of the cross-section of the film, in this case which is illustrated as a principle, according to the system of FIG. 7 in alternating sequence. In the remaining cross-section, only the décor 41 is serially arranged. By this measure, it is possible in quite a simple manner to make the tilting or moving image effects visible only in a partial region of the surface of the sports equipment, whereby particularly exclusive decors can be attained.

According to the variant embodiments described, three-dimensional decors, tilting as a function of the angle of view, are formed, viewed over the cross-section, i.e. in Y and Z direction of FIG. 4. When using the surface textures according to FIG. 9, an additional three-dimensional effect can also be attained in X-direction, based on the imprints of the motifs according to FIGS. 5 to 8, since the film 4 is provided with nodule-shaped lenses 5. The lines 51 and 52 in FIG. 9 constitute meridians and have been entered here only to show that these are lenticular nodules. These lenticular nodules can be arranged with geometric precision, e.g. in rows with constant spacings in Y- and X-directions, or offset, e.g., as illustrated in FIG. 10, or also with statistic distribution.

FIG. 11a shows a top view on a film 4 according to FIG. 9, wherein the motif 41 which is printed onto the planar lower side of the film is statistically arranged, whereby, depending on the angle of view, differently large parts of the motif 41 are visible and, thus, again the impression of a moving background is generated.

FIG. 11b shows a top view onto a film 4 according to FIG. 9, wherein the motifs 41, 42, 43, 44 each are geometrically arranged in a quarter circle, resulting in an image which constantly changes, depending on the angle of view.

1-6. (canceled)

7. A decorating method for sports equipment, comprising:
providing a transparent synthetic material film configured as a lenticular grid film formed with a matrix of planar-convex lenses and having a substantially planar lower side;
imprinting the lower side by screen-printing a pattern formed of different image elements for creating a decorative changing image and/or an animation effect upon viewing through the lenticular grid film; and
joining the film to a piece of sports equipment.

8. The method according to claim 7, which comprises joining the imprinted film to a ski or to a snowboard.

9. A film for carrying out the method according to claim 7, comprising:
a foil with a surface texture and a planar side, said a surface texture being formed with a series of optical lenses having a planar convex cross-section;
each said optical lens being formed by an individual strand and having a focal point located below said foil; and
image elements or motifs disposed on said planar side of said foil.

10. The film according to claim 9, wherein said image elements or motifs are disposed one after another in alternating sequence.

11. The film according to claim 9, wherein voids are disposed between the motifs.

12. The film according to claim 9, wherein geometrically disposed motifs are each arranged in a quarter circle.

13. The film according to claim 9, wherein said different image elements are provided only over part of the cross-section of said foil in alternating sequence, and the motifs or image elements are serially arranged only in a remaining part.

14. A film for decorating sports equipment, comprising:
a foil with a surface texture and a planar side, said a surface texture being formed with a series of optical lenses having a planar convex cross-section;
each said optical lens being formed by an individual strand and having a focal point located below said foil; and
image elements or motifs disposed on said planar side of said foil.

15. The film according to claim 14, wherein said image elements or motifs are disposed one after another in alternating sequence.

16. The film according to claim 14, wherein voids are disposed between the motifs.

17. The film according to claim 14, wherein geometrically disposed motifs are each arranged in a quarter circle.

18. The film according to claim 14, wherein said different image elements are provided only over part of the cross-section of said foil in alternating sequence, and the motifs or image elements are serially arranged only in a remaining part.
